(19) United States
(12) Patent Application Publication
(10) Pub. No.: US 2003/0097431 A1
(43) Pub. Date: May 22, 2003

(54) Ethernet firewall multi-access appliance

(76) Inventor: Russell J. Dill, Phoenix, AZ (US)

Correspondence Address: Peter B. Scull, 4818 W. 31st Ave., Denver, CO, 80212, US

(21) Appl. No.: 10/256,548

(22) Filed: Sep. 28, 2002

Related U.S. Application Data
(60) Provisional application No. 60/326,084, filed on Sep. 29, 2001.

(51) Int. Cl. G06F 15/177

(52) U.S. Cl. 709/221; 713/201

(57) ABSTRACT

An easy to use combination connectivity, firewall, and web administration programmed hardware invention is presented. The hardware likely uses two accessory boards connected to a host computer or host file server. The auxiliary board is likely an Ethernet board. The main board includes a CPU, flash memory, DRAM, and likely an external power supply. The invention assures that its necessary portions are activated prior to the activation of the host file server or computer. In part, this involves flash memory, the blob boot loader, and the use of a Linux kernel. The software automatically performs connectivity, firewall, and web administration functions. As best envisioned, the configuration of the software is user adjustable. Portions of the invention may be password protected. The password protection may be required before the restricted software portions of the invention may be manually or automatically updated via an Intranet or over the Internet.

### INTRODUCTION

In general, the present invention relates to programmed Internet and networking appliances attached to a host computer. More particularly, this invention relates to a UNIX based programmed accessory board attached to a host computer that allows a user to easily setup user configurable connectivity, firewall and web administration hardware and software for a computer.

### BACKGROUND OF THE INVENTION

Like other paradigm shifting technical advances, the Internet possesses the capacity for both great promise, and great peril. Like fire, one must use it carefully, skillfully, and respectfully, or one may get burned, and have ones assets and even business destroyed. The proliferation of malevolent viruses in multiple guises, is just one facet of the dark side of computer interconnection. Outright data theft, site destruction, and even identity theft are other consequences of our increased use of interconnected computers.

The growth of computer memory, processing speed and data capacity has been nothing short of incredible. Twenty-five years ago a computer with 64 Kilobytes (K) of Random Access Memory (RAM) was exceptional, now 64 Megabytes of RAM is grossly substandard. Spreadsheet programs such as VisiCalc once functioned within the confines of this 64K limitation, now such a program would be laughed at.

Once dumb terminals connected to a central computer were considered advanced. Then computing advanced to a network having a central file server with some distributed computing ability. Now, peer to peer networks are common.

A processing speed of 1 Megahertz (MHz) was once considered fast, now processing speeds of well over 1000 MHz, 1 GHz, are common. In a like fashion 300 baud was once a fast modem, now dial up modems at over 50,000 baud are now considered hopelessly slow. The cutting edge for Internet usage is broad band, and a continuous Internet connection. This boon creates new and previously unimagined problems. Possibly, these problems can best be understood by briefly considering the nature of the human spirit.

Sometimes, the greatest challenges in human accomplishment are attempted for no other reason than that, “they are there”, e.g. the Matterhorn, the Eiger, Everest, and maybe even the trips to the moon. Computer hackers are similarly achievement driven. If a constant web portal exists they want to access it just because it is there. Therefore any persistent Internet connection is going to attract hackers, or other threats. Protection from these threats is mandatory. Accordingly, any user, or network, connected to the Internet requires a firewall, and other appropriate software. Any network of computers requires interconnections, and an agreed set of protocols. Any web site requires administration.

At present, each of these tasks is generally performed separately. The closest to a standardized, out of the box solution to any of these problems, is the use of network cards such as Ethernet cards. While these cards were once expensive and unreliable, now, in the year CE 2001, reliability, simplicity, and transparent connectivity have generally been obtained, or are at least attainable. Unfortunately, this is the case with neither firewalls nor web site administration.

Firewalls are sufficiently complicated, obtuse, and arcane to have been used in the Dilbert cartoon to make fun of Senior Management, “do you smell smoke? Maybe the firewall is burning again.” Current firewalls are a necessary implement to attempt to assure computer and network security, but are roundly cursed far more than they are praised. They are custom, not standardized applications, make Windows 95 look heavenly by comparison, and are unstable. Needless to say they are both temperamental and high maintenance. Their only possible good point is that in comparison with the current state of the art of web site administration, they are goodness incarnate.

After all, firewalls are at least automated. The need for automated web administration is best, and most eloquently demonstrated by the proliferation of human Web Administrators. The costs, and time, consumed, or wasted if you prefer, by, and on web administration, is immense and likely expanding rapidly. For those of ordinary skill in the art, nothing more need be said.

Plainly a need exists for a standardized device that can perform the interconnection, firewall, and web administration functions. Ideally, such a device would also be user configurable, modular, and have stable low maintenance operating programming capable of receiving automatic updates. This need is not being met. Meeting this need is the purpose of the present invention.

### BRIEF SUMMARY OF THE INVENTION

In brief, the present invention is a board, preferrably having its own independent power supply, along with an Ethernet card, volatile and non-volatile memory, and the appropriate programming adapted for connection with a host server or computer. The invention performs both the interconnectivity functions of a router and an Ethernet card, the protective functions of a firewall, and the web administration function.

For purposes of stability, the programming is built around Linux. For purposes of illustration, this programming is assumed to be a Linux kernel. Also, for purposes of clarity to those skilled in the art, standard UNIX acronyms are used throughout.

While the present invention is intended for use with a computer or network, it can exist as a stand-alone device.

The operation of the present invention may be summarized as follows. The invention commences operation at powerup. The device may operate intermittently. If flash memory is used, this flash memory is at the base of the memory map allowing the code therein to begin executing. This code is commonly known as the blob boot loader. This code determines whether the rescue boot or normal boot partition should be booted. The boot blob loader then jumps to the loaded kernel.

The kernel then enables boot up. Upon completing booting, the root file system is passed through to it. Once the kernel has mounted the root filesystem, the kernel executes the init process specified on the kernel command line. The boot processes are partition specific.

If the rescue boot partition is indicated, the init process is an ftp daemon. If the default partition is indicated, the init process is a designated shell script most commonly called startup. In the event of a rescue, the ftp daemon waits for an ftp connection. After receiving an ftp connection it accepts the transferred file most likely the default firmware from the user, copies the file into flash memory, and reboots the system from the default partition.

The default, or normal, startup script mounts various file directories. These directories may include /etc, /var, and /tmp and are preferably mounted as a ramfs, other file formats may be used. This allows these files to be modified at run time. The startup script also mounts the proc file system. The hardware watchdog, FTP daemon, ident daemon, HTTP daemon, and configuration-reset daemon are started, before the specific startup programs.

The startup programs first reads the journaled config file from the flash memory. These programs then configure the internal networking interface. Next, they may check for an Internal DHCP server and assign itself an IP address, or may start its own DHCP server if so configured, and then set its own IP address per the configuration. The external interface is then configured in accordance with the configuration, with a DHCP or PPPoE client being started if needed. The firewall and NAT rules are then set up as per the configuration.

The DNS forwarding server is then started. Port forwards and blocks, as well as any internal routes are then setup. The vpn clients, server, and routing daemon are then started if enabled by the configuration.

The web administration is done through the HTTP daemon. This access is disallowed on the outside interface. Some data or functions, such as main page and current status CGI executable are accessible to all users, and may be stored in the HTTP root directory. If desired, access to other administration pages may be limited to those having the proper administration password, as is well known to those skilled in the art. To save space, CGI programs may be written in C with a shared library.

The firmware associated with the present invention may preferably be updated. This updating may be accomplished through the FTP daemon, by downloading the firmware from the Internet. Most commonly if an administration password is enabled, use of the password is required to access this function. Upon a firmware update, the startup programs are updated, and the device may be rebooted as desired.

The required hardware of the present invention is of course subject to modification. Presently, this hardware consists of a CPU, flash memory, Dynamic Random Access Memory (DRAM) and a power supply on board, along with an Ethernet board as a second board. The boards may be constructed in a modular manner. Other devices such as a DSL modem card, or a hard drive controller may also be provided.

The firmware is also designed around a Linux kernel in a modular manner. The hardware is presently programmed through a standardized JTAG interface. The software may be programmed in any desired manner. For rapid prototyping purposes, existing flash memory modules of Linux kernel Memory Technology Devices (MTD) were used. This was accomplished through writing a mapping driver to interconnect the MTD with the JTAG interface. This allowed the flash memory to be modified exactly as if it were on the host system.

Accordingly, the prime object of the present invention is to provide a user configurable programmed board that acts as a firewall.

Another object of the present invention is to provide a user configurable programmed board that performs both firewall and web administration functions.

These and still further objects as shall hereinafter appear are fulfilled by the present invention in a remarkably unexpected manner as can readily be discerned from the following detailed description of an exemplary embodiment of the present invention particularly when read in conjunction with the accompanying drawings in which like parts bear like reference throughout the several views.

### BRIEF DESCRIPTION OF THE DRAWING

FIG. 1. is a system block diagram of the hardware portion of the present invention.

### DESCRIPTION OF THE PREFERRED EMBODIMENT

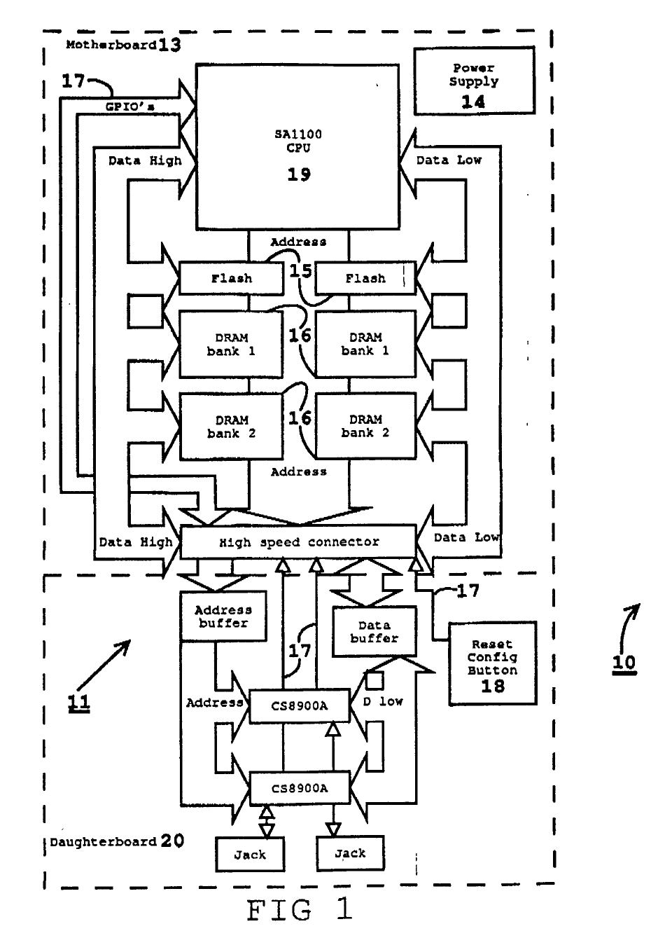

As shown in FIG. 1, a preferred embodiment of the present invention referred to throughout by the general reference 10 is described below. The present invention is adapted for connection to a host computer or network.

Many other configurations of the present invention will of course be apparent to one of ordinary skill in the art. In fact, the manner in which this invention operates is far more important than the precise hardware or software expedients discovered to date.

The present invention 10 comprises hardware 11, and software mounted thereon. As presently conceived, hardware 11 comprises a main board 13, having an interconnected power supply means 14, flash memory 15, DRAM 16, input output bus 17, rescue boot button 18 and a CPU 19 operatively connected thereto, and a second board 20, comprising an Ethernet board.

The present invention 10 also performs numerous processes. These will be described sequentially. They begin with the boot process.

The board 13 may be powered continuously, if desired, but such is not necessary. The boot process begins when the board is powered up, preferably from power supply means 14. If desired, the host computer or server may supply the power. This causes the CPU 19 to come out of reset. When the CPU 19 begins executing code, it begins so at the base of the memory stack. This may also be represented as 0×00000000.

As currently best known to the inventor, the flash memory 15 is at the base of the memory map. Therefore the code in the flash memory 15 begins executing. The code at the base of the flash memory is the blob boot loader. If desired another boot loader may be used.

The blob boot loader initializes the DRAM 16 and CPU 19 on the board 13. Next it sets the flash memory speed, enables the I-cache, and sets up the stack pointer. The boot loader then jumps to C code.

Upon beginning to execute C code the blob boot loader tests the state of a designated input/output bus 17 to establish the state of the rescue boot button 18. This determines whether the board will boot from the default, or rescue partition.

Before booting a partition the boot loader determines what filesystem is contained thereon. After the type of filesystem has been determined, the boot loader calls the code to load the kernel from that filesystem. The boot loader then turns off the I-cache, sets the architecture number, and jumps to the kernel that has been loaded.

The kernel turns on all the caches, and begins any needed decompression. After then jumping to the uncompressed code, the MMU is enabled and the page tables are set up. After parsing the command line, the kernel enables IRQ's. The kernel then initializes each piece of hardware on the system. After completing booting the kernel mounts the root filesystem passed to it through the kernel options. Once the root is mounted the kernel executes the init process directed by the selected boot partition.

If the rescue partition has been designated, the init process is an ftp daemon. The ftp daemon in the rescue partition waits for an ftp connection. When the ftp connection is received, the ftp daemon accepts a file from the user and saves it into main memory. Upon completing the transfer, the received file is copied into flash memory. The system is then rebooted from the default partition.

The default partition init process is a shell script called startup. This script mounts /etc, /var, and /tmp as a ramfs so files in these directories can be modified at run time. This script also mounts the proc filesystem. The root file system is cramfs for production and jffs2 for development. The startup script copies the init-etc directory to /etc to populate the directory. The startup script then executes a statically linked sysvinit.

Sysvinit then begins processing the init scripts. The rcS.d scripts, which setup the hostname and default network settings, are executed. Sysvinit then enters runlevel 2 and executes the rc2.d scripts. These scripts start the hardware watchdog, FTP daemon, ident daemon, HTTP daemon and the configuration reset daemon. The scripts then start the specific startup programs.

First, the startup programs read the journaled config from the parameter flash blocks. The startup programs then configure the internal networking interface, checking for an internal DHCP server if requested, assigning itself an IP address if one was found, or starting its own DHCP server if the configuration dictates and one has not been found, and then settings its own IP address as per the configuration. The startup programs then configure the external interface as dictated by the user definable configuration, starting a DHCP client or PPPoE client if necessary. The startup scripts then setup the firewalling and NAT rules, in accordance with the configuration.

The DNS forwarding server is then started. Port forwards and blocks are then setup, as well as any internal routes. If enabled, the vpn clients, server, and routing daemon are then started. Attention is next directed to the web administration function.

The web administration is done through the HTTP daemon and access is disallowed on the outside interface. Most likely, the main page, and current status CGI executable files are stored in the HTTP root directory and are accessible to all users, even if an administration password is enabled. All of the other administration pages require an administrator password if it is enabled. The web pages load the configuration from the journaled flash memory block and then display it to the user. The user can then change the configuration and apply it, at which point it is saved to the journaled config file and the parameters are made to take effect. The CGI programs are most likely written in C with a shared library to allow shared functions. This would make the code most space and operationally efficient.

Most likely, it would also be desirable to enable firmware updates. Firmware updates are done through the FTP daemon. The user downloads the updated firmware from the Internet, and then connects to the FTP daemon on the device. If the administration password is enabled, the firmware update function is most preferably password protected. The authorized user, after entering the appropriate password then uploads the firmware. Once the send is complete, the FTP daemon logs off the user, and tells the init program to enter runlevel 3.

Entering runlevel 3 kills all processes except sysvinit (including the ftpd daemon). The runlevel 3 scripts then copies a small, statically linked flashing program into ram, and then executes it. The flashing program flashes the device, syncs, and then reboots the device.

The hardware 11 of the present invention 10 comprises a main board with a SA-1100 CPU, 4M flash, 32M DRAM, and a power supply, and two Ethernet chips with jacks on a second board. These hardware components are just one example of many suitable devices that could perform these functions, as is apparent to one skilled in the art.

The CPU is a SA-1100 chip from Intel®. It contains an ARM core, MMU, data cache, instruction cache, four serial buses, a DRAM controller, and a series of general-purpose I/O pins. A QFP package was used instead of a BGA package because it required less time to route, and was easier to debug and make minor modification to as the board was prototyped. Production of large quantities could well lead to selecting other equivalent packages.

The flash footprints on the board were made to be compatible with the widest array of flash chips possible. The footprint chosen was TSOP with three zero ohm jumpers to accommodate for slightly different flash pin outs. The flash chosen for the prototype run was AMD29LV160DB flash. This is a 1×16 Mbit flash memory. Two of these memories interleaved together create 4 Mbytes of flash.

The DRAM on the board consists of four Micron 64 Mbit dynamic ram forming a total of 32 Mbytes of ram. There are two banks, each with two chips, this means that one bank can easily be removed, leaving the board with 16M of DRAM.

The power supply consists of a 3.3V supply, chained to a 2.0V power supply. The 3.3V supply works off of a Maxim 1626, while the 2.0V power supply works off of a Maxim 1623. Both power supplies uses an easily configurable number of tantalum capacitors.

The main board also contains a diagnostics LED, a set of buffers for a serial port, a JTAG connector for testing and programming, and a supervisory IC to detect and react to dips in the power source, as well as provide a manual reset.

The dual Ethernet board contains two CS8900A Ethernet chips, two Transpower filtered Ethernet jacks, two 74LVC16245 data and address buffers, two 74LVC00 chips for decode, three LED'S, a button and a switch debouncer for that button.

The Ethernet chips are Cirrus Logic CS8900A Ethernet chips. They were chosen for their high throughput, small footprint, ISA interface, existing drivers, and low cost. The chips are connected through the SA 1100's PCMCIA interface, which is very similar to an ISA interface. The interrupt pins are connected to two of the SA 1100 GPIO (General-Purpose Input/Output) pins.

Because board space was limited, Transpower Ethernet jacks with built in filters were used. The jacks not only provide and Ethernet jack and filter in the same package, they are also surface mount.

The data and address buffers are used because the two Ethernet chips would push the SA 1100 over its 50 pF capacitance load limit. Their direction is determined by the decoding logic.

The decode chips are two sets of four NAND gates. They determine which chip is being selected, as well as the direction for the data buffers.

The three LEDs are connected directly to three GPIO's on the SA1100 and can be easily controlled to display the status of the device. There is also a push-button switch connected through a switch debouncer to another SA1100 GPIO. This will be used to reset the configuration and boot to the rescue image. The debouncer creates a clean, digital signal from the switch, as well as protecting the CPU from ESD (electrostatic discharge).

The boards are designed in a modular fashion so that the product can be modified at a minimal cost. Currently, the only peripheral board is the dual Ethernet board. New peripheral boards can be designed and prototyped at a very low cost and added to the existing main board base and firmware. The peripheral board can also be stacked together to combine functionality. Such as a hard disk controller board along with a dual Ethernet board to provide an ICSA certified firewall.

As mentioned above, the firmware is designed around a Linux kernel and has a standard base of general and network applications. A minimal amount of software can be added to this base to perform various functions ranging from dos (Quality of Service), to Internet connection sharing/firewall, to a full IDS (Intrusion Detection System). The firmware is usually cross-compiled on an i386 machine for the arm target, but can also be natively compiled. The firmware images can also easily be compiled for i386 to work on an i386 target in the future (as well as other architectures).

To program the board, the JTAG interface is used. JTAG is a standardized means of communicating with defined registers on a CPU. The SA-1100 has a boundary scan interface register. This register can set/clear/ view/change direction of all the pins on the SA-1100 one by one. Using this interface, it is possible to slowly program the on board flash memory. The JTAG interface has three inputs (TMS, TDI, and TCLK), and one output (TDO). The interface being used to connect to the JTAG interface is a custom ISA card. Each of the outputs to the JTAG device are routed through 3.3V buffers. The TDO signal is routed through a buffer that is controlled by (nCS & nMEMR), and is connected to DO. The TDI and TMS buffers are connected to D0 and D1. The TCLK buffer is connected to (nCS & nMEMW).

For rapid prototyping purposes, the existing flash memory modules of the Linux kernel (MTD, Memory Technology Devices) were used to communicate with and send commands to the flash devices on the board. To accomplish this, a mapping driver was written to allow MTD to send and read data over the JTAG interface. Once this was done, the flash could be erased, read, and written exactly as if it were on the host system.

Possibly the following additional details on the operation of the web administration software portion of the invention would be of interest. They are as follows:

Writing of configuration files is done to the ramfs. Config files for each daemon as well as for the system wide settings are saved. A different function is used to write out each config file. Config files for a connection are written out in a more general way from info from the module's parameter list.

System configurations are stored long term in the flash memory. Two flash blocks are used to assure that the configuration will not be lost if power fails while it is being written. Each flash block is alternately filled, and erased as subsequent config files are written. Each config has a revision number, and a CRC to assure that data is not lost. The entire system config directory is tarred and gripped before stowing in the flash memory.

In addition, configurations are read through a general parser. It is used to parse both system config files, as well as files written by daemons to indicate their status. A config reader that examines the parameter list for that connection module reads configuration files for the connections in a more general way.

When an admin page is requested, the associated CGI program is run in order to generate the page. Each dynamic page has an associated compiled C program. Each program starts by reading in the associated set of config files and displaying an HTML header by using the helper HTML functions. The options are then displayed in appropriate dialog boxes, again, using the helper HTML functions. Standard buttons such as help, return to main page, and apply are then displayed along with the footer. The HTML is displayed to the user by outputting it to standard out. The HTTP daemon then transmits that data to the user.

As in Windows 98, for example, a user is prompted to verify configuration choices by clicking on an “apply” button on the screen. When the user chooses to hit the apply button, the web server passes each setting to the CGI program as environmental variables. The settings are then read in by the config parser and examined. The proposed configuration is examined against a set of rules. If the configuration entered by the user is found to be invalid, a message is displayed, and the user is given the option to go back and correct these mistakes. If the settings are valid, the new settings are displayed and the CGI program disconnects from the web server.

The CGI program then calls the appropriate functions to write and commit the configuration, as well as to make it take effect. Some CGI are cyclic, in that they accept the new config, and then display the settings for changing again. These pages also make use of the HTML functions to perform common tasks such as displaying headers and footers.

The HTML helper functions perform commonly used HTML display operations. They display headers, footers, background tags, forms, and buttons. This set of functions is used to reduce total size, and to standardize the interface.

Because the present invention functions as a DHCP server, and there can only be one DHCP server on the network, the present invention attempts to detect an existing DHCP server on the network. If one is found, it assigns it settings based on the lease that that DHCP server hands out, and then disables its own DHCP server.

A connection monitor monitors a connection for faults. If a fault occurs, such as being disconnected, the monitor does what is necessary to bring that connection up, possibly resetting hardware and/or re-dialing. The connection monitor also provides its current status to the web administration pages. The behavior and jobs of the connection monitor vary from connection type to connection type.

Ports are forwarded from the product to machines on the network to allow them to allow Internet accesses to services such as a HTTP, web or FTP server. Port forwards are applied when the connection comes up. In addition, ports that provide services to the interior network are blocked from the outside, such as the FTP daemon for firmware updating, as well as the web administration. Static routes are handled similarly to port forwards, but they are always up.

As discussed above, firmware updates are done through a continually running FTP daemon. The firmware updates are in the form of the root file system, and contain a kernel. The FTP daemon ideally uses the same username/password as the web administration for logins. Once the image is uploaded, all running processes are killed, and a switch is made to a small, temporary root file system in ram. This file system then flashes the new image, and reboots the present invention.

If the product becomes unreachable because of an unusable configuration or forgotten admin password, pressing the internal reset configuration button with a pin or other suitable device can clear the configuration. When a button press is detected, the configuration is erased, and the present invention is then reset.

If power fails during a firmware update, or a corrupted firmware is uploaded, the present invention could then also go into an unusable state. A small, secondary partition with a FTP daemon is included in case such a failure occurs. This has previously been discussed as the rescue partition. Holding down the configuration-reset button during a power cycle accesses this partition.

Because full information of both networks is needed to make a VPN connection, but the user is only required to implement minimal information, for example a password on the server side, and a password and server IP on the client side, an information trading session must be initiated by the client. When the connection comes up, the client starts attempting to connect to the server. When a connection is made, the client and server authenticate each other with the shared pass phrase, i.e. the phrase must match. The information about each network is then traded over an encrypted channel. A full VPN connection can later be made based on this information. Once this trade has been made, a full connection is set up on both ends, the client then connects to the server, and the pass phrase is once again authenticated. Once connected, both networks can communicate through a secure TCP/IP tunnel.

Because a machine can connect to as many servers as necessary, each server can accept as many clients as necessary, and a node can be both a client, and a server, therefore, a network of VPN connections can be created. To manage and interconnect these multiple networks, a routing daemon is run on each node. When a VPN connection comes up, the routing daemon is notified. The routing daemon then determines what routes it should apply to the current node, and what routes to pass on to its neighbor nodes. Each route is given a scalar based on the connection speed, and the number of hops. The daemon also listens for notification about routes elsewhere on the VPN network, and does the same (apply, and forward to other nodes). The opposite action and notification occurs when a node leaves the network. In this way, multiple VPN networks can be linked in a seamless, efficient, and fault tolerant way.

Each connection method (such as DHCP client, or PPPOE) is isolated in a module. Each module has a list of parameters that should be saved/restored, as well as displayed and changed by the user in the web administration. Each connection method also has a set of interface functions where by it can be notified of changes, and it can notify the rest of the system of changes. Further, any function set to NULL is not implemented.

At boot, all services, as well as the connection are started based on the config in place as described above.

From the foregoing, it is readily apparent that all of the aforestated objects have been fulfilled by the present invention in a remarkably unexpected fashion. It is of course understood that all modifications and alterations as may readily occur to the artisan having ordinary skill in the art to which this invention pertains are included within the present invention, which is limited solely by the scope of the claims appended hereto.

1. A programmable accessory board for a host computer provides comprising:
A) a main board in operative communication with said host computer,
B) a CPU mounted upon said main board and in operative communication with said host computer,
C) a power supply for said main board independent of said host computer connected to said main board
D) memory operatively connected to said main board and said CPU,
E) communication means operatively connected to said CPU:

2. A board according to claim 1 also comprising:
F) configuration software connected to said CPU,
G) site administration firmware operatively connected to said CPU
H) connectivity hardware and software operatively connected to said CPU; and
I) firewall software operatively connected to said CPU and said host computer.

3. A board according to claim 2 wherein said configuration software is user configurable.

4. A board according to claim 2 wherein said administration software has a plurality of access codes.

5. A board according to claim 3 wherein said administration software has a plurality of access codes.

6. A board according to claim 5 wherein said memory comprises a plurality of memory types.

7. A board according to claim 2 wherein said software may be updated without user intervention.

8. A board according to claim 4 wherein said software may be updated without user intervention.

9. A board according to claim 5 wherein said software may be updated without user intervention.

10. A device for automatically providing connectivity, site administration and firewall services for a network having a file server comprising a main board having a CPU connected to said server, an Ethernet board in communication with said main board, and software controlling said boards.

11. A device according to claim 10 wherein said main board is powered by a power supply independent of said server.

12. A device according to claim 10 wherein said software is at least in part user configurable.

13. A device according to claim 11 wherein said software is at least in part user configurable.

14. A device according to claim 10 wherein said software is at least in part updateable without user intervention.

15. A device according to claim 12 wherein said software is at least in part updateable without user intervention.

16. A device according to claim 13 wherein said software is at least in part updateable without user intervention.

17. An invention comprising automated web administration software.

18. An invention according to claim 17 also comprising firewall software.

19. An invention according to claim 17 also comprising connectivity software.

20. An invention according to claim 19 also comprising connectivity software.
